(19) United States
(12) Patent Application Publication
(10) Pub. No.: US 2018/0115882 A1
(43) Pub. Date: Apr. 26, 2018

(54) USER TERMINAL AND CONTROL METHOD

(71) Applicant: KYOCERA CORPORATION, Kyoto (JP)

(72) Inventor: Hiroyuki ADACHI, Kawasaki-shi, Kanagawa (JP)

(73) Assignee: KYOCERA CORPORATION, Kyoto (JP)

(21) Appl. No.: 15/564,712

(22) PCT Filed: Apr. 6, 2016
(86) PCT No.: PCT/JP2016/061327

§ 371 Date: Oct. 5, 2017

Related U.S. Application Data
(60) Provisional application No. 62/145,739, filed on Apr. 10, 2015.

(51) Int. Cl. H04W 8/00; H04W 72/02; H04W 72/04; H04W 56/00

(52) U.S. Cl. CPC H04W 8/005; H04W 56/0015; H04W 72/0406; H04W 72/02

(57) ABSTRACT

A user terminal according to a first embodiment is used in a mobile communication system configured to support Device to Device (D2D) communication that is direct device-to-device communication. The user terminal comprises a transmitter configured to transmit, out of a cell coverage, a signal to another user terminal synchronized with the user terminal; a receiver configured to receive a signal from the another user terminal; a storage configured to store a D2D discovery signal resource pool, and a transmission probability parameter indicating a probability of transmission of a D2D discovery signal in the D2D discovery signal resource pool; and a controller configured to execute a process of adjusting the transmission probability parameter in accordance with a resource usage amount in the D2D discovery signal resource pool.

### TECHNICAL FIELD

The present application relates to a user terminal and a communication control method used in a mobile communication system configured to support device-to-device (D2D) communication that is direct device-to-device communication.

### BACKGROUND ART

In 3GPP (3rd Generation Partnership Project) which is a project aiming to standardize a mobile communication system, the introduction of a device to device (D2D) proximity service is discussed as a new function in Release 12 and onward (see Non Patent Document 1).

The D2D proximity service (D2D ProSe) is a service enabling direct device-to-device communication within a synchronization cluster including a plurality of synchronized user terminals. The D2D proximity service includes: a D2D discovery procedure (ProSe Discovery) in which a proximal terminal is discovered; and D2D communication (ProSe Communication) that is direct device-to-device communication.

### PRIOR ART DOCUMENT

### Non-Patent Document

Non Patent Document 1: 3GPP technical report “TR 36.843 V12.0.1” Mar. 27, 2014

### SUMMARY

A user terminal according to one embodiment is used in a mobile communication system configured to support Device to Device (D2D) communication that is direct device-to-device communication. The user terminal comprises a transmitter configured to transmit, out of a cell coverage, a signal to another user terminal synchronized with the user terminal; a receiver configured to receive a signal from the another user terminal; a storage configured to store a D2D discovery signal resource pool, and a transmission probability parameter indicating a probability of transmission of a D2D discovery signal in the D2D discovery signal resource pool; and a controller configured to execute a process of adjusting the transmission probability parameter in accordance with a resource usage amount in the D2D discovery signal resource pool.

### BRIEF DESCRIPTION OF THE DRAWINGS

FIG. 1 is a configuration diagram of an LTE system according to an embodiment.

FIG. 2 is a block diagram of a UE (user terminal) according to the embodiment.

FIG. 3 is a block diagram of an eNB (base station) according to the embodiment.

FIG. 4 is a protocol stack diagram of a radio interface in an LTE system.

FIG. 5 is a configuration diagram of a radio frame used in the LTE system.

FIG. 6 is a diagram illustrating an operation environment according to the embodiment.

FIG. 7 is a diagram illustrating a configuration of resource pools for a D2D discovery signal.

FIG. 8 is a sequence diagram illustrating an operation state according to the embodiment.

### DESCRIPTION OF THE EMBODIMENTS

### Overview of Embodiments

In the D2D ProSe, a scenario is assumed in which a plurality of synchronized user terminals are located out of a cell coverage (out of coverage). In such a scenario, the plurality of user terminals located out of the cell coverage perform device-to-device communication directly, without passing through a network. Thus, for an optimal operation in this scenario, it is desirable to efficiently perform a D2D discovery procedure among the plurality of user terminals.

Therefore, the embodiments provide a user terminal and a control method that can realize efficient D2D discovery procedure when a plurality of synchronized user terminals are located outside the cell coverage. A user terminal according to the embodiments is used in a mobile communication system configured to support Device to Device (D2D) communication that is direct device-to-device communication. The user terminal comprises a transmitter configured to transmit, out of a cell coverage, a signal to another user terminal synchronized with the user terminal; a receiver configured to receive a signal from the another user terminal; a storage configured to store a D2D discovery signal resource pool, and a transmission probability parameter indicating a probability of transmission of a D2D discovery signal in the D2D discovery signal resource pool; and a controller configured to execute a process of adjusting the transmission probability parameter in accordance with a resource usage amount in the D2D discovery signal resource pool.

In the embodiments, the controller is configured to execute a process of transmitting, to the another user terminal, information on an adjusted parameter obtained by adjusting the transmission probability parameter.

In the embodiments, the user terminal is a synchronization source for the another user terminal. The controller is configured to execute, upon transmitting a synchronization signal from the user terminal to the another user terminal, a process of also transmitting the information on the adjusted parameter.

In the embodiments, the controller is configured to execute: a process of detecting a resource usage amount of the other user terminal in the D2D discovery signal resource pool; and a process of adjusting the transmission limit probability parameter in accordance with the detected resource usage amount. The controller is further configured to stop a process of transmitting a D2D discovery signal from the user terminal while executing the process of detecting the resource usage amount of the other user terminal.

In the embodiments, the controller is configured to execute a process of transmitting a D2D discovery signal, based on the adjusted parameter.

In the embodiments, the controller is configured to execute, after executing the process of transmitting, to the other user terminal, the information on the adjusted parameter, a process of transmitting a D2D discovery signal based on the adjusted parameter.

In the embodiments, the controller is configured to execute a process of adjusting the transmission probability parameter so that the probability is low as the resource usage amount in the D2D discovery signal resource pool is large.

In the embodiments, the controller is configured to execute a process of adjusting the transmission probability parameter so that the probability is high as the resource usage amount in the D2D discovery signal resource pool is small.

A user terminal according to the embodiments is used in a mobile communication system configured to support Device to Device (D2D) communication that is direct device-to-device communication. The user terminal comprises a transmitter configured to synchronize, out of a cell coverage, with another user terminal that is a synchronization source to transmit a signal to the other user terminal; a receiver configured to receive a signal from the other user terminal; a storage configured to store a D2D discovery signal resource pool, and a transmission probability parameter indicating a probability of transmission of a D2D discovery signal in the D2D discovery signal resource pool; and a controller configured to execute a process of adjusting the transmission probability parameter. The controller is configured to adjust, if obtaining information on an adjusted parameter transmitted from the other terminal, the transmission probability parameter by using the information on the adjusted parameter. The adjusted parameter is a parameter obtained by adjusting, by the another user terminal, a transmission probability parameter stored in the other user terminal, in accordance with a resource usage amount in the D2D discovery signal resource pool.

A control method in a user terminal according to the embodiments is used in a mobile communication system configured to support Device to Device (D2D) communication that is direct device-to-device communication. The control method comprises detecting, out of a cell coverage, a resource usage amount in a D2D discovery signal resource pool; adjusting, in accordance with the detected resource usage amount, a transmission probability parameter indicating a probability of transmission of a D2D discovery signal in the D2D discovery signal resource pool; and transmitting, to another user terminal synchronized with the user terminal, information on an adjusted parameter obtained by adjusting the transmission probability parameter.

A control method in a user terminal according to the embodiments is used in a mobile communication system configured to support Device to Device (D2D) communication that is direct device-to-device communication. The control method comprises obtaining, out of a cell coverage, information on an adjusted parameter transmitted from another user terminal that is a synchronization source; and adjusting a transmission probability parameter stored in the user terminal, by using the information on the obtained adjusted parameter. The transmission probability parameter is a parameter indicating a probability of transmission of a D2D discovery signal in a D2D discovery signal resource pool. The adjusted parameter is a parameter obtained by adjusting, by the other user terminal, a transmission probability parameter stored in the other user terminal, in accordance with a resource usage amount in the D2D discovery signal resource pool. The control method further comprises transmitting a D2D discovery signal, based on the adjusted transmission probability parameter.

### Embodiment

An embodiment in which the present disclosure is applied to an LTE system will be described, below.

### System Configuration

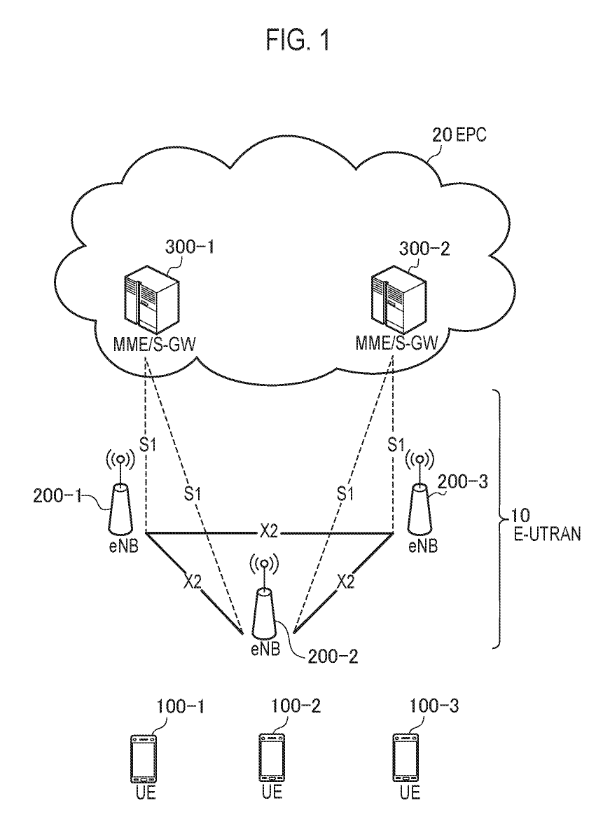

FIG. 1 is a configuration diagram of the LTE system according to the embodiment. As illustrated in FIG. 1, the LTE system according to the embodiment comprises a UE (User Equipment) 100, an E-UTRAN (Evolved-UMTS Terrestrial Radio Access Network) 10, and an EPC (Evolved Packet Core) 20.

The UE 100 corresponds to a user terminal. The UE 100 is a mobile communication apparatus, which performs radio communication with a cell (serving cell) with which connection is established. The configuration of the UE 100 will be described later.

The E-UTRAN 10 corresponds to a radio access network. The E-UTRAN 10 comprises an eNB 200 (evolved Node-B). The eNB 200 corresponds to a base station. The eNB 200 is connected mutually via an X2 interface. The configuration of the eNB 200 will be described later.

The eNB 200 manages one or a plurality of cells, and performs radio communication with the UE 100 which establishes a connection with a cell of the eNB 200. The eNB 200 has a radio resource management (RRM) function, a routing function of user data, a measurement control function for mobility control and scheduling, and the like. The “cell” is used as a term indicating a smallest unit of a radio communication area, and is also used as a term indicating a function of performing radio communication with the UE 100.

The EPC 20 corresponds to a core network. A network of the LTE system (LTE network) is configured by the E-UTRAN 10 and the EPC 20. The EPC 20 comprises an MME (Mobility Management Entity)/S-GW (Serving-Gateway) 300. The MME performs different types of mobility control and the like for the UE 100. The S-GW performs transfer control of the user data. The MME/S-GW 300 is connected to the eNB 200 via an S1 interface.

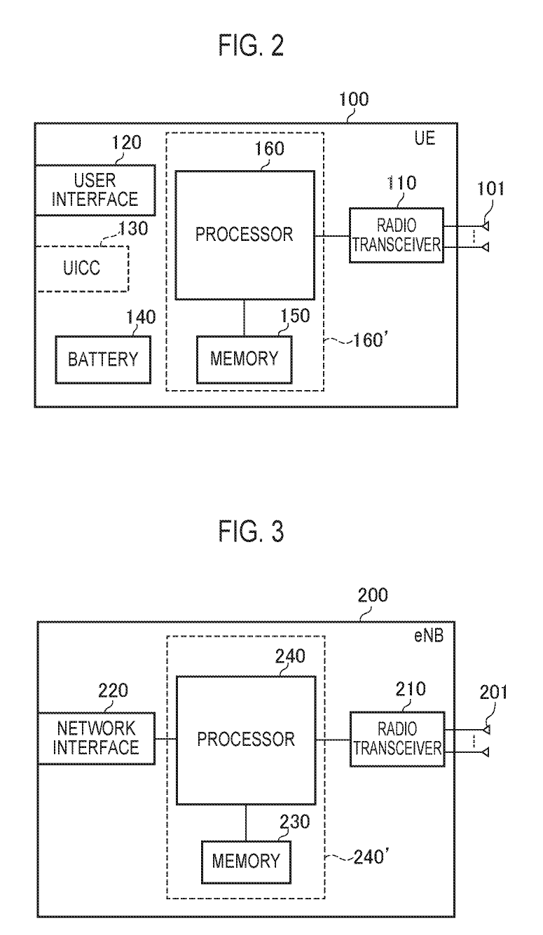

FIG. 2 is a block diagram of the UE 100. As illustrated in FIG. 2, the UE 100 comprises an antenna 101, a radio transceiver 110, a user interface 120, a UICC (Universal Integrated Circuit Card) 130, a battery 140, a memory 150, and a processor 160. The memory 150 corresponds to a storage unit and the processor 160 corresponds to a controller. Furthermore, the memory 150 may be integrally formed with the processor 160, and this set (in other words, a chip set) may be used as a processor 160′ (controller) forming a controller. The controller executes various processes and various communication protocols described later.

The antenna 101 and the radio transceiver 110 are used to transmit and receive a radio signal. The radio transceiver 110 converts a baseband signal (a transmission signal) output from the processor 160 into a radio signal, and transmits the radio signal from the antenna 101. Furthermore, the radio transceiver 110 converts a radio signal received by the antenna 101 into a baseband signal (reception signal), and outputs the baseband signal to the processor 160. The radio transceiver 110 and the processor 160 configure a transmitter and a receiver.

The radio transceiver 110 may comprise a plurality of transmitter units and/or a plurality of receiver units. In the embodiment, a case is mainly assumed where the radio transceiver 110 comprises one transmitter unit and one receiver unit only.

The user interface 120 is an interface with a user carrying the UE 100, and comprises, for example, a display, a microphone, a speaker, and various buttons. The user interface 120 receives an operation from a user and outputs a signal indicating the content of the operation to the processor 160.

The UICC 130 is a removable storage medium that stores therein subscriber information. The UICC 130 may be called SIM (Subscriber Identity Module) or USIM (Universal SIM). The UICC 130 stores the “pre-configured parameter” described later.

The battery 140 accumulates power to be supplied to each block of the UE 100. In case that the UE 100 is a card-type terminal, the UE 100 may not comprise the user interface 120 nor the battery 140.

The memory 150 stores a program to be executed by the processor 160 and information to be used for a process by the processor 160.

The processor 160 includes a baseband processor that performs modulation and demodulation, encoding and decoding and the like on the baseband signal, and a CPU (Central Processing Unit) that performs various processes by executing the program stored in the memory 150. The processor 160 may further include a codec that performs encoding and decoding on sound and video signals. The processor 160 executes various types of processes and various types of communication protocols described later.

FIG. 3 is a block diagram of the eNB 200. As illustrated in FIG. 3, the eNB 200 comprises an antenna 201, a radio transceiver 210, a network interface 220, a memory 230, and a processor 240 (controller). It is noted that the memory 230 is integrated with the processor 240, and this set (in other words, a chipset) may be used as a processor 240′ (controller) forming a controller.

The antenna 201 and the radio transceiver 210 are used to transmit and receive the radio signal. The radio transceiver 210 converts a baseband signal (a transmission signal) output from the processor 240 into a radio signal, and transmits the radio signal from the antenna 201. Furthermore, the radio transceiver 210 converts a radio signal received by the antenna 201 into a baseband signal (reception signal), and outputs the baseband signal to the processor 240. The radio transceiver 210 and the processor 240 configure a transmitter and a receiver.

The network interface 220 is connected to the neighboring eNB 200 via the X2 interface and is connected to the MME/S-GW 300 via the S1 interface. The network interface 220 is used in communication performed on the X2 interface and communication performed on the S1 interface.

The memory 230 stores a program to be executed by the processor 240 and information to be used for a process by the processor 240.

The processor 240 includes a baseband processor that performs modulation and demodulation, encoding and decoding and the like on the baseband signal and a CPU that performs various types of processes by executing the program stored in the memory 230. The processor 240 executes various types of processes and various types of communication protocols described later.

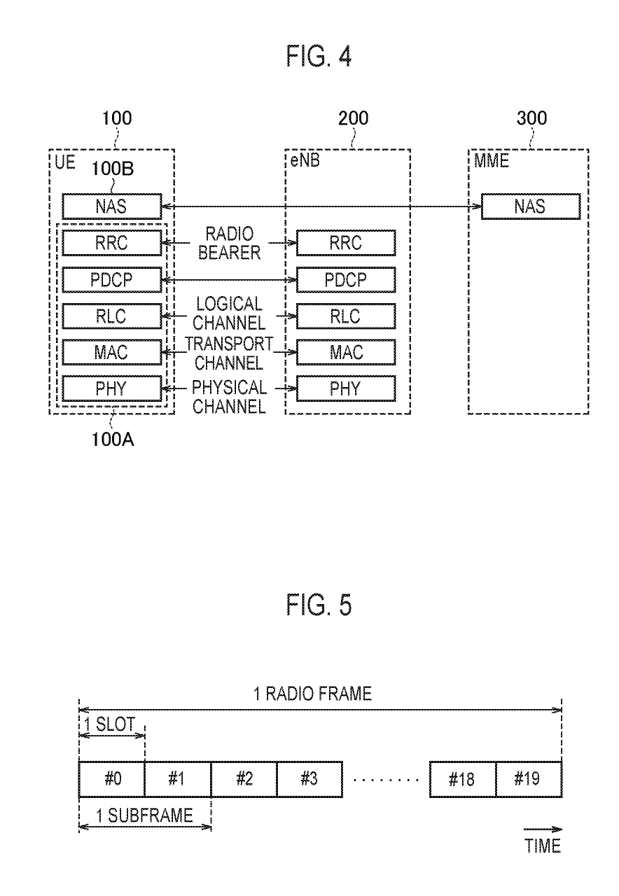

FIG. 4 is a protocol stack diagram of a radio interface in the LTE system. As illustrated in FIG. 4, the radio interface protocol is classified into a first layer to a third layer of an OSI reference model, such that the first layer is a physical (PHY) layer. The second layer includes a MAC (Medium Access Control) layer, an RLC (Radio Link Control) layer, and a PDCP (Packet Data Convergence Protocol) layer. The third layer includes an RRC (Radio Resource Control) layer.

The physical layer performs coding and decoding, modulation and demodulation, antenna mapping and demapping, and resource mapping and demapping. Between the physical layer of the UE 100 and the physical layer of the eNB 200, user data and control signals are sent via a physical channel.

The MAC layer performs priority control of data, and a retransmission process and the like by a hybrid ARQ (HARQ). Between the MAC layer of the UE 100 and the MAC layer of the eNB 200, user data and control signals are sent via a transport channel. The MAC layer of the eNB 200 includes a scheduler for determining (scheduling) a transport format (a transport block size and a modulation and coding scheme) of an uplink and a downlink, and a resource block to be allocated to the UE 100.

The RLC layer sends data to an RLC layer of a reception side by using the functions of the MAC layer and the physical layer. Between the RLC layer of the UE 100 and the RLC layer of the eNB 200, user data and control signals are sent via a logical channel.

The PDCP layer performs header compression and decompression, and encryption and decryption.

The RRC layer is defined only in a control plane that handles control signals. Between the RRC layer of the UE 100 and the RRC layer of the eNB 200, a control signal (RRC message) for various types of configurations is sent. The RRC layer controls a logical channel, a transport channel, and a physical channel depending on the establishment, re-establishment, and release of a radio bearer. In case that there is a connection (an RRC connection) between the RRC of the UE 100 and the RRC of the eNB 200, the UE 100 is in an RRC connected mode. Otherwise, the UE 100 is in an RRC idle mode.

An NAS (Non-Access Stratum) layer positioned above the RRC layer performs session management, mobility management, and the like.

In the UE 100, the physical layer to the RRC layer configure an AS (Access Stratum) entity 100A. The NAS layer configures an NAS entity 100B. Functions of the AS entity 100A and the NAS entity 100B are executed by the processor 160 (controller). In other words, the processor 160 (controller) includes the AS entity 100A and the NAS entity 100B. In the idle mode, the AS entity 100A performs the cell selection/reselection, and the NAS entity 100B performs the PLMN selection.

FIG. 5 is a configuration diagram of a radio frame used in the LTE system. In the LTE system, OFDMA (Orthogonal Frequency Division Multiple Access) is applied to a downlink (DL), and SC-FDMA (Single Carrier Frequency Division Multiple Access) is applied to an uplink (UL), respectively.

As illustrated in FIG. 5, a radio frame is configured by 10 subframes arranged in a time direction. Each subframe is configured by two slots arranged in the time direction. Each subframe has a length of 1 ms and each slot has a length of 0.5 ms. Each subframe includes a plurality of resource blocks (RBs) in a frequency direction, and a plurality of symbols in the time direction. Each of the resource blocks includes a plurality of subcarriers in the frequency direction. A resource element is configured by one subcarrier and one symbol. Of the radio resources allocated to the UE 100, a frequency resource is configured by a resource block, and a time resource is configured by a subframe (or a slot).

### Overview of D2D Discovery Procedure

A D2D discovery procedure for a D2D proximity service according to the embodiment will be mainly described, below. An LTE system according to the embodiment supports the D2D proximity service.

The D2D proximity service (D2D ProSe) is a service enabling direct UE-to-UE communication within a synchronization cluster including a plurality of synchronized UEs 100. The D2D proximity service includes: a D2D discovery procedure (ProSe Discovery) in which a proximal UE is discovered; and D2D communication (ProSe Communication) that is direct UE-to-UE communication. The D2D communication may be referred to as Direct communication.

A scenario in which all the UEs 100 forming the synchronization cluster are located in a cell coverage is called “In coverage”. A scenario in which all the UEs 100 forming the synchronization cluster are located out of a cell coverage is called “Out of coverage”. A scenario in which some UEs 100 in the synchronization cluster are located in a cell coverage and the remaining UEs 100 are located out of the cell coverage is called “Partial coverage”.

It is assumed that the D2D discovery procedure is performed in “In coverage”, “Out of coverage”, and “Partial coverage”.

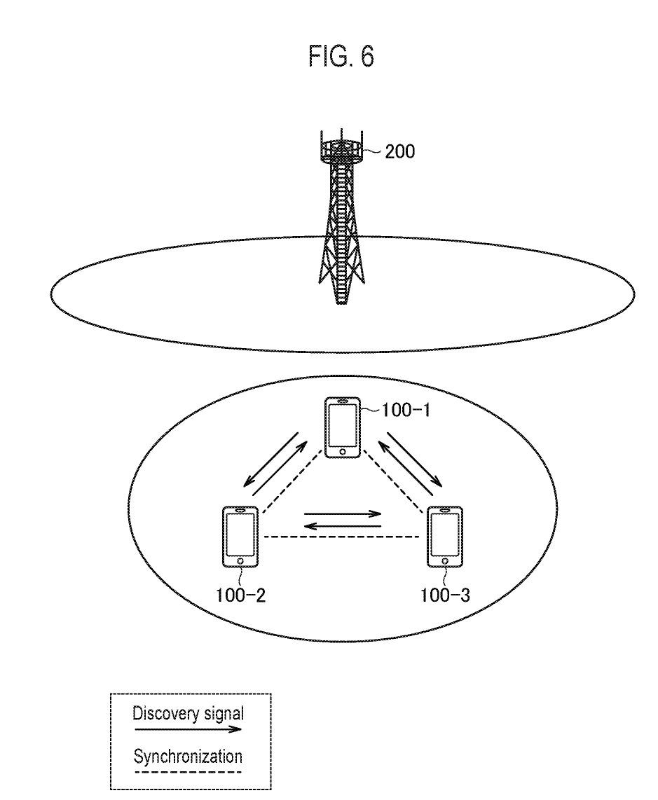

In the present embodiment, an “Out of coverage” scenario, illustrated in FIG. 6, will be described. FIG. 6 is a diagram illustrating an operation environment according to the embodiment.

In FIG. 6, a situation is illustrated in which outside a coverage of the eNB 200, a UE 100-1, a UE 100-2, and a UE 100-3 utilize the D2D proximity service. It is noted that three UEs 100 are illustrated in FIG. 6, however, at least two UEs 100 are necessary.

In FIG. 6, it is assumed that the UE 100-1 is a synchronization source, and the UE 100-2 and the UE 100-3 are asynchronous sources. The UE 100-1, the UE 100-2, and the UE 100-3 are assumed to synchronize with each other with the UE 100-1 being the synchronization source. While synchronizing with each other, the UE 100-1, the UE 100-2, and the UE 100-3 execute a D2D discovery procedure.

In the D2D discovery procedure, each UE 100 (the UE 100-1, the UE 100-2, and the UE 100-3) transmits a D2D discovery signal (Discovery signal) for discovering a proximal terminal.

Schemes of the D2D discovery procedure include: a first scheme (Type 1 discovery) in which a radio resource not uniquely allocated to the UE 100 is used for transmitting the D2D discovery signal; and a second scheme (Type 2 discovery) in which a radio resource uniquely allocated to each UE 100 is used for transmitting the D2D discovery signal.

In the first scheme, a D2D discovery signal resource pool is used for transmitting the D2D discovery signal. The D2D discovery signal resource pool is shared in the synchronization cluster including the plurality of synchronized UEs 100.

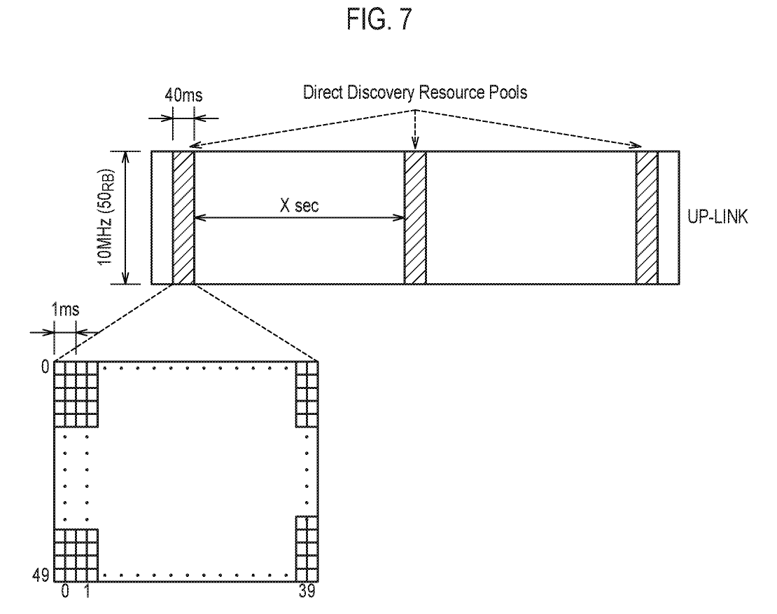

FIG. 7 is a diagram illustrating a configuration of D2D discovery signal resource pools. The D2D discovery signal resource pools (Direct Discovery Resource Pools) are constituted in the uplink.

In the example of FIG. 7, the D2D discovery signal resource pool may be constituted in a resource region having 10 MHz (50 resource blocks) bandwidth and 40 ms in the time direction. The D2D discovery signal resource pool is constituted for each X sec. (X can take, for example, any one value of “0.32”/“0.64”/“1.28”/“2.56”/“5.12”/“10.24”). The plurality of synchronized UEs 100 transmit the D2D discovery signal by using a time-frequency resource (resource block) in the D2D discovery signal resource pool. It is noted that the D2D discovery signal resource pool may be shared with a D2D communication resource pool.

In the present embodiment, an example is assumed in which an operation in the first scheme is executed. The following description is provided as an operation content in the first scheme.

In the first scheme, a constitution of the above-described D2D discovery signal resource pool, and other information elements (such as a “tx-Probability parameter” described later) are pre-configured. Hereinafter, a parameter that is pre-configured, is referred to as a “pre-configured parameter”. It is noted that, in each of the information elements (the constitution of the D2D discovery signal resource pool, and other information elements) included in the pre-configured parameter, identical pre-configured parameters are configured for UEs used for identical purposes (military, fire-fighting, police, and the like). In this context, if a plurality of resource pools are configured for the D2D discovery procedure, an individual tx-Probability parameter may be configured for each of the resource pools.

It is noted that information indicating the constitution of the D2D discovery signal resource pool includes: a parameter specifying a time-frequency domain in which the D2D discovery signal resource pool is initially constituted in a radio frame (an offset value for designating a start position); a parameter designating a resource in a frequency direction in the D2D discovery signal resource pool (frequency direction resource-designating parameter); a repeat period of the D2D discovery signal resource pool; and information (bit map information) indicating whether a certain subframe is a time-frequency resource that can be used for the D2D discovery procedure.

The Pre-configured parameter is provided to the UE 100. Here, it is assumed that the Pre-configured parameter is stored in advance in the UICC 130 of the UE 100. It is noted that if the Pre-configured parameter is not stored in advance in the UICC 130, the UE 100 may store the Pre-configured parameter in the memory 150 by being provided from a network (such as OAM) via the eNB at a predetermined occasion.

### tx-Probability Parameter

The tx-Probability parameter indicates a transmission probability of the D2D discovery signal (announcement in a discovery) in the D2D discovery signal resource pool. The tx-Probability parameter is prescribed as “P25” indicating a transmission probability of 25%, “P50” indicating a transmission probability of 50%, “P75” indicating a transmission probability of 75%, and “P100” indicating a transmission probability of 100%. In this context, “P100” means that the D2D discovery signal is certainly transmitted by a certain time-frequency resource in the D2D discovery signal resource pool.

For one UE 100, one tx-Probability parameter (any one of “P25”, “P50”, “P75”, or “P100”) is configured as the pre-configured parameter. It is noted that, for an “out of coverage” scenario, the tx-Probability parameter may be prescribed as a value other than “P25”, “P50”, “P75”, or “P100”.

### D2D Discovery Procedure in “Out of Coverage” Scenario

As described above, the plurality of UEs 100 out of the coverage, included in the synchronized cluster, may operate according to the first scheme. Each of the UEs 100 has one respective tx-Probability parameter (that may be a common parameter or a different parameter). In accordance with the respective tx-Probability parameter, each of the UEs 100 selects a time-frequency resource in the D2D discovery signal resource pool, based on a predetermined selection criteria, and transmits the D2D discovery signal by using the selected time-frequency resource.

In this case, one tx-Probability parameter is pre-configured for each the UEs 100. If the tx-Probability parameter is fixed in each of the UEs 100, the following situation may be assumed.

First, a situation of transmission delay of the D2D discovery signal is assumed. This may occur if a usage amount of the time-frequency resource for transmitting the D2D discovery signal is small (low-load state) in a certain D2D discovery signal resource pool. For example, even though being in the low-load state in the D2D discovery signal resource pool, a probability is high that a UE 100 having “P25” tx-Probability parameter does not transmit the D2D discovery signal in the D2D discovery signal resource pool, because the transmission probability of the D2D discovery signal in the UE 100 is low. In such a case, if the D2D discovery signal is not transmitted in the D2D discovery signal resource pool, a next occasion of the D2D discovery signal resource pool has to be awaited. Thus, transmission of the D2D discovery signal may be delayed.

Next, a situation of collision of D2D discovery signals is assumed. This may occur if a usage amount of the time-frequency resource for transmitting the D2D discovery signal is large (high-load state) in a certain D2D discovery signal resource pool. For example, even though being in a high-load state in the D2D discovery signal resource pool, a probability is high that a UE 100 having “P100” tx-Probability parameter transmits the D2D discovery signal in the D2D discovery signal resource pool, because the transmission probability of the D2D discovery signal in the UE 100 is high. This is because, if UEs 100 having a high transmission probability of the D2D discovery signal occur in a large number, a probability is high that the D2D discovery signals of a plurality of UEs 100 collide in the D2D discovery signal resource pool. Thus, a technology is required to avoid the above-described situation, that is, to efficiently perform the D2D discovery procedure among the plurality of user terminals in the “out of coverage” scenario. Such a technology is described below.

### Description of Operation According to the Present Embodiment

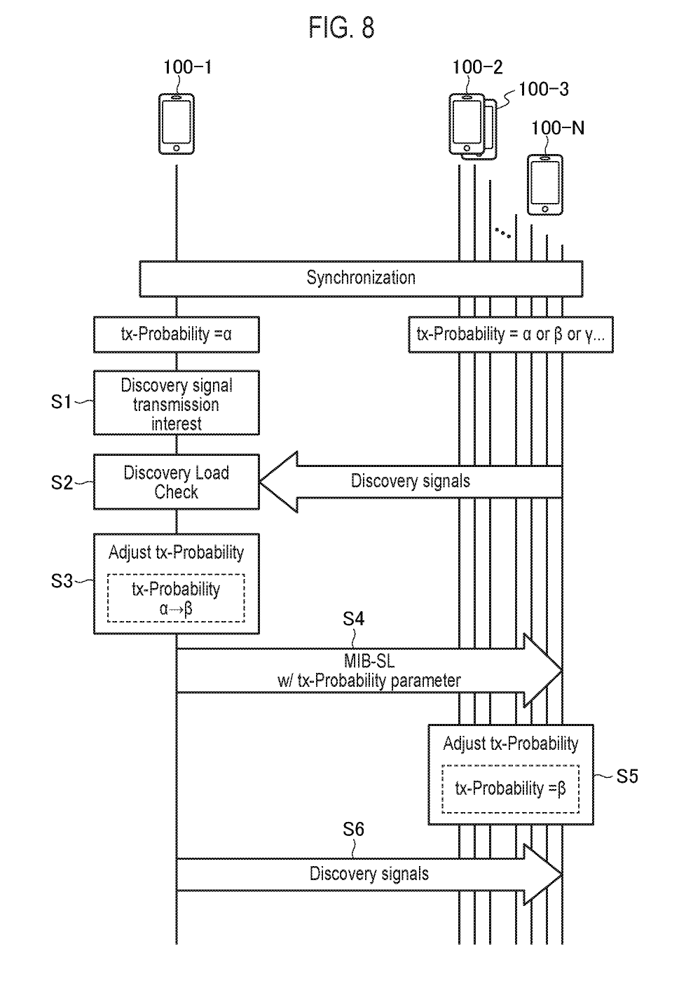

An operation content of the present embodiment will be described below with reference to FIG. 8. FIG. 8 is a sequence diagram illustrating an operation state according to the embodiment. It is noted that a process executed by the UE 100 is executed by the controller 160 (160′) of the UE 100, however, for convenience, description of FIG. 8 is given on the assumption that the UE 100 performs the process.

In FIG. 8, a plurality of UEs 100 (UEs 100-1 to N) perform the D2D discovery procedure out of the coverage. Among the plurality of UEs 100 (UEs 100-1 to N), the UE 100-1 is a synchronization source and the other UEs 100 (UEs 100-2 to N) are asynchronous sources. The plurality of UEs 100 (UEs 100-1 to N) synchronize with each other with the UE 100-1 being the synchronization source.

Here, each UE 100 of the plurality of UEs 100 (UEs 100-1 to N {N≥2}) stores, in advance in the UICC 130: information indicating the constitution of the D2D discovery signal resource pool; and the Pre-configured parameter including the tx-Probability parameter. In an example of FIG. 8, the UE 100-1 configures “a” as the tx-Probability parameter. “a” is assumed to be any one of the above-described “P25”, “P50”, “P75”, and “P100”. It is noted that “a” may be a value other than “P25”, “P50”, “P75”, or “P100”. In the present embodiment, the UEs 100-2 to N store, in advance in the UICC 130: information indicating the constitution of the D2D discovery signal resource pool; and the Pre-configured parameter including the tx-Probability parameter (any one of “α”, “β”, “γ”, . . . ). Here, “α”, “β”, “β”, . . . indicate the above-described transmission probability; and “α”, “β”, “γ”, . . . each indicate a different transmission probability.

Under these circumstances, first, the UE 100-1 that is the synchronization source, has an interest in transmitting a D2D discovery signal (step S1).

Therefore, the UE 100-1 that is the synchronization source, monitors a D2D discovery signal from the other UEs 100-2 to N in the D2D discovery signal resource pool, and detects the D2D discovery signal from the other UEs 100-2 to N. Thus, the UE 100-1 checks (calculates/detects) the usage amount (Discovery Load) of the time-frequency resource with which the D2D discovery signal is transmitted in the D2D discovery signal resource pool (step S2).

In this case, based on the information indicating the constitution of the D2D discovery signal resource pool stored in the UICC 130 of the UE 100-1, the UE 100-1 puts on hold a process of transmitting the D2D discovery signal from the user terminal, even if an occasion arises for transmitting the D2D discovery signal from the UE 100-1 (a period of the D2D discovery signal resource pool arrives).

As a result of checking the usage amount of the time-frequency resource with which the D2D discovery signal is transmitted, the UE 100-1 executes a process of adjusting (modifying/selecting/generating/calculating) the tx-Probability parameter, in accordance with the usage amount of the time-frequency resource (step S3).

In step S3, the UE 100-1 adjusts the tx-Probability parameter from “α” to “β” in accordance with the usage amount of the time-frequency resource with which the D2D discovery signal is transmitted. The UE 100-1 overwrite saves in the UICC 130 or stores in the memory 150 the adjusted tx-Probability parameter “β”. The stored specific content of the adjustment process will be described anew.

Next, the UE 100-1 includes information on the adjusted tx-Probability parameter “β” (adjusted parameter) in, for example, a master information block-sidelink (MIB-SL) message (control information), and broadcasts a radio signal including the MIB-SL to the UEs 100-2 to N (step S4). It is noted that the UE 100-1 may broadcast the information on the adjusted tx-Probability parameter “β” included in a control message other than the MIB-SL.

In step S4, the information on the adjusted tx-Probability parameter “β” broadcast by the UE 100-1, is information indicating the “β” itself. It is noted that the information on the adjusted tx-Probability parameter “β” may be identification information (such as an offset value from the transmission probability stored before) enabling the UEs 100-2 to N to indirectly identify the “β”.

Upon receiving the radio signal including the MIB-SL broadcast from the UE 100-1, the UEs 100-2 to N temporarily store, in the memory 150, the information on the adjusted tx-Probability parameter “β” included in the MIB-SL. Thereafter, the UEs 100-2 to N execute a process of adjusting (modifying/selecting/generating/calculating) the tx-Probability parameter stored in the UICC 130 of each of the UEs 100, to become the adjusted tx-Probability parameter “β” stored in the memory 150 (step S5). Thereafter, the UEs 100-2 to N transmit a D2D discovery signal, based on: the information indicating the constitution of the D2D discovery signal resource pool stored in the UICC 130 of each of the UEs 100; and the adjusted tx-Probability parameter “β”.

After broadcasting the radio signal including the MIB-SL, the UE 100-1 transmits a D2D discovery signal for the UEs 100-2 to N, based on: the information indicating the constitution of the D2D discovery signal resource pool stored in the UICC 130 of the UE 100-1; and the stored adjusted tx-Probability parameter “β” (step S6).

Afterwards, the UE 100-1 and the UEs 100-2 to N repeat the processes of steps S1 to S6. It is noted that after repeating the processes of steps S1 to S6 for a predetermined number of times, or after continuing the processes of steps S1 to S6 for a predetermined time duration, the UE 100-1 and the UEs 100-2 to N may adjust the tx-Probability parameter back to the initial value.

### Example of Adjustment of tx-Probability Parameter

An example of adjustment of the tx-Probability parameter in step S3 will be described. In step S2, as a result of checking the usage amount of the time-frequency resource with which the D2D discovery signal is transmitted, the UE 100-1 adjusts the tx-Probability parameter to be a low value as the usage amount of the time-frequency resource is large. For example, if the tx-Probability parameter “α” is “P100”, the UE 100-1 adjusts the tx-Probability parameter to be a value smaller than “P100” (at least any one of “P75”, “P50”, or “P25”).

Further, as a result of checking the usage amount of the time-frequency resource with which the D2D discovery signal is transmitted, the UE 100-1 adjusts the tx-Probability parameter to be a high value as the usage amount of the time-frequency resource is small. For example, if the tx-Probability parameter “α” is “P25”, the tx-Probability parameter is adjusted to be a value larger than “P25” (at least any one of “P50”, “P75”, or “P100”).

### Summary of the Present Embodiment

In the present embodiment, the tx-Probability parameter can be adjusted, as described above, in accordance with the usage amount of the time-frequency resource with which the D2D discovery signal is transmitted (Discovery Load). Therefore, a transmission delay of the D2D discovery signal and a collision between the plurality of user terminals can be effectively suppressed in the “out of coverage” scenario.

### Other Embodiments

In the above-described embodiment, the UE 100-1 notifies the UEs 100-2 to N of information on one adjusted tx-Probability parameter. However, for example, the UE 100-1 may, in accordance with the usage amount of the time-frequency resource with which the D2D discovery signal is transmitted, generate a plurality of tx-Probability parameters and notify the UEs 100-2 to N of information on the plurality of generated tx-Probability parameters. In this case, the UEs 100-2 to N can use more adequate information selected from information on the plurality of tx-Probability parameters, under consideration of an operation environment of each of the UEs 100.

It is noted that examples of the above-described embodiment and the other embodiments are described for a scenario in which the D2D discovery procedure is performed according to the first scheme (Type 1 discovery) in “out of coverage”, however, an implementation in the following scenario is also possible.

For example, an implementation for a scenario in which the UE 100-1 performs D2D communication according to Mode-2 in “out of coverage”, is also possible. Here, the “Mode-2” operation in the D2D communication denotes an operation in which the UE 100 itself selects, from a resource pool, a radio resource for transmitting D2D data (D2D data and/or control data). In the “Mode-2” in the D2D communication, the UE 100-1 may adjust tx-Probability parameters (one or more parameters) for a resource pool for the D2D communication and transmit the adjusted tx-Probability parameters to the UEs 100-2 to N.

Further, in the scenario in which the UE 100-1 performs D2D communication according to the Mode-2 in “out of coverage”, there is also a scenario for transmitting the D2D discovery signal in the resource pool for the D2D communication. This scenario may be referred to as “Discovery through Communication (DtC)”. In this “DtC” scenario, the UE 100-1 may adjust tx-Probability parameters (one or more parameters) for a resource pool for the D2D communication in which transmission of the D2D discovery signal is possible, and transmit the adjusted tx-Probability parameters to the UEs 100-2 to N. In this context, two operation modes (Mode-1/Mode-2) of the D2D communication are defined. Of the two modes, the Mode-2 corresponds to the above description. On the other hand, in the Mode-1, the eNB 200 or a relay node not illustrated allocates a radio resource for transmitting the D2D data (D2D data and/or control data).

In the above-described embodiment, although an LTE system is described as an example of the mobile communication system, the present application is not limited to the LTE system and may be applied to a system other than the LTE system.

### Appendix

### 1. Introduction

WID of including the following objective was agreed.

Define enhancement (if needed) to D2D discovery to enable the following features.

Type 1 discovery for the partial and outside network coverage scenarios targeting public safety use

### 2. Discussion

One thing which RAN2 should consider about the synchronization is the inter-cell discovery scenario specified in Rel-12. According to the current specification, InC UE near the edge of coverage can perform discovery operation by transmitting only one-shot SLSS on the (nearest subframe from) beginning of discovery transmission resource pool. So InC UE near the edge of coverage should select suitable SLSS transmission method depends on Public Safety discovery or Commercial discovery operation.

Proposal 1: ProSe UE should select suitable SLSS transmission method depends on Public Safety discovery or Commercial discovery operation.

### 2.1.1. Other Enhancements

### Pool Selection

For inside network coverage operation, serving cell/PCell can configure the multiple transmission resource pool and the way of the pool selection (random/RSRP based) to ProSe UE. On the other hand, for outside network coverage operation, there's no pool selection scheme in the preconfigured parameters for Communication, therefore, it may be not necessary to reuse the pool selection scheme for inside network coverage. However, in consideration of the aspects of discovery range, new pool selection scheme based on the discovery range can be used.

Proposal 2: It should discuss whether pool selection scheme based on the discovery range is necessary or not.

### Discovery Message Load Control (txProbability)

Serving cell/PCell can configure the txProbability to control the load of discovery message generated by type 1 discovery announcing. Serving cell/PCell configures txProbability via dedicated/broadcast signalling, so txProbability can be modified based on the type 1 discovery resource pool condition (by eNB's implementation). However, for outside network coverage case, if txProbability is reused, it needs to be pre-configured to ProSe UE, so it can't be modified based on the resource pool condition. If load control mechanism should be necessary for outside network coverage, we need to discuss how to select suitable value for txProbability, e.g. based on the number of discovery message in resource pool, based on the reception power of discovery resource pool or etc.

Proposal 3: It should discuss whether load control mechanism for outside network coverage is necessary or not.

### 3. Conclusion

In this contribution, we have an observation and six proposals for partial and outside network coverage discovery.

### Cross Reference

The entire content of U.S. provisional application No. 62/145739 (filed on Apr. 10, 2015) is incorporated in the present specification by reference.

### INDUSTRIAL APPLICABILITY

The present application is useful in the field of communication.

1. A user terminal used in a mobile communication system configured to support Device to Device (D2D) communication that is direct device-to-device communication, comprising:
a transmitter configured to transmit, out of a cell coverage, a signal to another user terminal synchronized with the user terminal;
a receiver configured to receive a signal from the another user terminal;
a storage configured to store a D2D discovery signal resource pool, and a transmission probability parameter indicating a probability of transmission of a D2D discovery signal in the D2D discovery signal resource pool; and
a controller configured to execute a process of adjusting the transmission probability parameter in accordance with a resource usage amount in the D2D discovery signal resource pool.

2. The user terminal according to claim 1, wherein
the controller is configured to execute a process of transmitting, to the another user terminal, information on an adjusted parameter obtained by adjusting the transmission probability parameter.

3. The user terminal according to claim 2, wherein
the user terminal is a synchronization source for the another user terminal, and
the controller is configured to execute, upon transmitting a synchronization signal from the user terminal to the another user terminal, a process of also transmitting the information on the adjusted parameter.

4. The user terminal according to claim 1, wherein
the controller is configured to execute:
a process of detecting a resource usage amount of the other user terminal in the D2D discovery signal resource pool; and
a process of adjusting the transmission limit probability parameter in accordance with the detected resource usage amount, and
the controller is further configured to stop a process of transmitting a D2D discovery signal from the user terminal while executing the process of detecting the resource usage amount of the other user terminal.

5. The user terminal according to claim 1, wherein
the controller is configured to execute a process of transmitting a D2D discovery signal, based on the adjusted parameter.

6. The user terminal according to claim 1, wherein
the controller is configured to execute
after executing the process of transmitting, to the other user terminal, the information on the adjusted parameter, a process of transmitting a D2D discovery signal based on the adjusted parameter.

7. The user terminal according to claim 1, wherein
the controller is configured to execute a process of adjusting the transmission probability parameter so that the probability is low as the resource usage amount in the D2D discovery signal resource pool is large.

8. The user terminal according to claim 1, wherein
the controller is configured to execute a process of adjusting the transmission probability parameter so that the probability is high as the resource usage amount in the D2D discovery signal resource pool is small.

9. A user terminal used in a mobile communication system configured to support Device to Device (D2D) communication that is direct device-to-device communication, comprising:
a transmitter configured to synchronize, out of a cell coverage, with another user terminal that is a synchronization source to transmit a signal to the other user terminal;
a receiver configured to receive a signal from the other user terminal;
a storage configured to store a D2D discovery signal resource pool, and a transmission probability parameter indicating a probability of transmission of a D2D discovery signal in the D2D discovery signal resource pool; and
a controller configured to execute a process of adjusting the transmission probability parameter, wherein
the controller is configured to adjust, if obtaining information on an adjusted parameter transmitted from the other terminal, the transmission probability parameter by using the information on the adjusted parameter; and
the adjusted parameter is a parameter obtained by adjusting, by the another user terminal, a transmission probability parameter stored in the other user terminal, in accordance with a resource usage amount in the D2D discovery signal resource pool.

10. A control method in a user terminal used in a mobile communication system configured to support Device to Device (D2D) communication that is direct device-to-device communication, comprising:
detecting, out of a cell coverage, a resource usage amount in a D2D discovery signal resource pool;
adjusting, in accordance with the detected resource usage amount, a transmission probability parameter indicating a probability of transmission of a D2D discovery signal in the D2D discovery signal resource pool; and
transmitting, to another user terminal synchronized with the user terminal, information on an adjusted parameter obtained by adjusting the transmission probability parameter.

11. A control method in a user terminal used in a mobile communication system configured to support Device to Device (D2D) communication that is direct device-to-device communication, comprising:
obtaining, out of a cell coverage, information on an adjusted parameter transmitted from another user terminal that is a synchronization source; and
adjusting a transmission probability parameter stored in the user terminal, by using the information on the obtained adjusted parameter, wherein
the transmission probability parameter is a parameter indicating a probability of transmission of a D2D discovery signal in a D2D discovery signal resource pool,
the adjusted parameter is a parameter obtained by adjusting, by the other user terminal, a transmission probability parameter stored in the other user terminal, in accordance with a resource usage amount in the D2D discovery signal resource pool, and
the control method further comprising:
transmitting a D2D discovery signal, based on the adjusted transmission probability parameter.
